(19) United States
(12) Patent Application Publication
(10) Pub. No.: US 2017/0197305 A1
(43) Pub. Date: Jul. 13, 2017

(54) Chisel Head Attachment For Electric Drills and Screw Drivers and the Like and Electric Chisels

(71) Applicant: Jahangir S. Rastegar, Stony Brook, NY (US)

(72) Inventor: Jahangir S. Rastegar, Stony Brook, NY (US)

(73) Assignee: Omnitek Partners LLC, Ronkonkoma, NY (US)

(21) Appl. No.: 14/991,981

(22) Filed: Jan. 10, 2016

(51) Int. Cl. B25F 3/00; B28D 1/28; B25D 11/10

(52) U.S. Cl. CPC B25F 3/00; B25D 11/102; B28D 1/28; B25D 2211/064; B25D 2250/025; B25D 2250/045

(57) ABSTRACT

A method for producing impacts from rotary motion, the method including: inputting the rotary motion to an input shaft, converting the rotary motion to a linear motion; storing potential energy in one or more elastic elements resulting from the linear motion; and releasing the stored potential energy when the stored potential energy reaches a predetermined level to accelerate an impact mass to produce the impact.

### BACKGROUND

1. Field

The present disclosure relates generally to chisels, and more particularly to chisel or hammer head attachments for portable electrical drills, portable electrical screw drivers, drill presses, and the like with changeable chisel tools or the like.

2. Prior Art

Chisels are used for breaking bricks or concrete blocks or the like; for roughing concrete or bricks; for driving rods into the ground; for scaling, chipping or chiseling; for caulking, tuck pointing, and removing old mortar; for light demolition; for cutting slots between holes; for removing scale, rust, and weld splatter; for digging in hard clay, packed dirt, or gravel; for cutting asphalt or hard ground; for removing tile and other various debris from floors; and the like. Manual chisels are very easy to use and is usually one of the most common tools that both professional and casual users. Electrically driven chisel units on the other hand are relatively large and expensive and are used mainly by professional users who routinely require the tool for their work.

In current electrically operated chisel units, the rotary motion of an electrical motor is used to provide a reciprocating motion of a hammer via a mechanism such as a crank shaft type or the like. The generated reciprocating motion is then used to drive a hammer mass to impact an anvil to which the chisel head is attached and is generally provided with sliding guides and relatively soft return springs. The hammer impact will then drive the chisel head forward to impact the intended surface and return quickly to or close to its rest position via the return spring before it is impacted again. In certain electric chisels the hammer mass is attached to the reciprocating mechanism via a spring to reduce the transmission of the impact shock load during hammer to anvil and the chisel impact to the operator.

In general, the relative size, weight and cost of such electrically driven chisel units makes them unattractive to very casual users or professional users who may rarely need the device, particularly if they have to carry it from job to job, particularly for light chiseling work.

A need therefore exists for relatively light weight, small and inexpensive electrically driven chisels, particularly for use by casual users and for professional users who may rarely need the device, particularly if they have to carry their tools from job to job or the like.

It is the object is to provide a method and related device designs for the development of highly effective chisel head attachment units, hereinafter referred to as “chisel head attachment units”, that are relatively small and lightweight and inexpensive that can be readily attached and/or directly driven by commonly used portable electrical drill units and electrical screw drivers.

It is also the object to provide methods and related device designs for the development of chisel head attachment units in which the driving electrically driven drill units or electrical screw drives would input mechanical energy into the units which is stored in potential energy storage spring(s) and are then released after the level of stored potential energy has reached a prescribed level, a “hammer” against which the potential energy storage spring element(s) are preloaded (in one or combination of compression, tension, bending and/or torsion) is released. As a result, at least a portion of the potential energy stored in the potential energy storage spring element(s) is transferred to kinetic energy of the hammer element. The hammer element would in turn impact at least one translating or rotating chisel head, thereby providing it with a forward momentum for impacting the intended target surface.

It is another object to provide methods and related device designs for the development of chisel head attachment units in which the prescribed level of generated impact force, i.e., the aforementioned prescribed level of potential energy stored in the device potential energy storage spring element(s), is readily adjustable by the user and is essentially independent of the type and power of the electrically drivel drill unit or electrically driven screw driver unit that is used to drive the present chisel head attachment units.

### SUMMARY

Accordingly, methods and related device designs are provided for the development of chisel head attachment units for electrically driven drills and electrically driven screw drivers with the capability of providing the means of adjusting the generated impact force levels to a desired level with a certain range.

The electrically driven drills and screw drivers may be of portable type that is driven by the AC power outlet or be driven by rechargeable batteries. The chisel head attachment unit may be similarly attached to the drill head of a drill press to provide the described chisel impacting action.

The disclosed chisel head attachment unit is comprised of: a body within which the device mechanisms are housed. The chisel head attachment unit body can be provided with a handle, such as a folding type, that the user hold with one hand to counter the rotational torque transmitted to the unit body as is described later in this disclosure and also for positioning the chisel at the desired positioning with respect to the surface to be impacted and for guiding over the desired path over the target surface. Alternatively, the chisel head attachment unit body may be provided properly formed surfaces to allow the user to directly hold the unit body in one hand. The latter design is particularly suitable for relatively small chisel head attachment units.

The driving electrical drill or screw driver chuck is then engaged to the head chisel attachment unit input drive, which can be formed with a hexagonal or similar cross-section for ease of being secure held to the drill or screw driver chuck. Commonly used hex-head adapters may also be used on electric screw drivers for quick engagement to and disengagement from the present chisel head attachment units.

The rotation of the chisel head attachment unit input drive is transmitted to a (potential energy storage) spring system preloading mechanism directly or via a speed reducing gearing to amplify the level of input torque. The input torque amplification mechanism would provide the means of achieving higher levels of force/torque for preloading the potential energy storage spring element(s), thereby to store larger amounts of potential energy in the spring elements(s). As a result, higher levels of chisel impact forces can be achieved. The speed reducing gearing is particularly necessary for chisel head attachment units that are required to provide high levels of chisel impact forces.

As the potential energy storage spring elements are preloaded, the spring system force/torque is directed to press on a hammer mass, which is prevented from moving in response to the applied force/torque via a provided stop element. Then as the input drive of the chisel head attachment unit is rotated a prescribed amount, thereby preloading and storing a prescribed amount of potential energy in the spring elements, the aforementioned hammer mass stop is pulled away, thereby allowing a portion such as a very larger portion of the potential energy stored in the spring elements to be transferred to the hammer mass as kinetic energy. The hammer mass element is then accelerated towards an anvil and impact the anvil and causes it to travel forward within a provided guide (or rotate for rotary type of chisel head attachment units). The chisel end (which can be separate chisel ends used for one or more of the aforementioned tasks) are directly and fixedly attached to the opposite end of the anvil element and together with the anvil element is provided with a forward momentum for impacting the intended target surface. The anvil element is also provided with a relatively light spring to bring it back to or towards its pre-impact rest position following each hammer impact.

The amount of chisel head attachment unit input drive rotation that causes the aforementioned hammer mass stop to be pulled back and release the hammer mass is adjusted by manually positioning the “stop engagement end” that is provided in the chisel head attachment mechanism.

It is appreciated by those skilled in the art that similar but in general smaller levels of chisel impact can be achieved by using input torque amplification other than gearings, for example by using a cam or a linkage type mechanism.

It is also appreciated by those skilled in the art that in certain applications, for example for roughing a concrete or other similar surface, only relatively low levels of chisel impact levels are required. For such applications, the torque amplification mechanisms such as gearing, cams or linkage mechanism type mechanisms are not required.

### BRIEF DESCRIPTION OF THE DRAWINGS

These and other features, aspects, and advantages of the apparatus will become better understood with regard to the following description, appended claims, and accompanying drawings where:

FIG. 1 illustrates the schematic overall view of a chisel head attachment unit and a typical portable electric drill or screw driver and their engagement mechanism.

FIG. 2 illustrates the schematic of the basic impact generating mechanism of one embodiment of the chisel head attachment unit.

FIG. 3 illustrates the schematic of an alternative embodiment of the basic impact generating mechanism of the chisel head attachment unit of FIG. 2.

FIG. 4 illustrates one method of adjusting the level of impact force between the chisel head attachment unit hammer and anvil.

FIG. 5 illustrates an alternative methods of adjusting the level of impact force between the chisel head attachment unit hammer and anvil.

FIG. 6 illustrates the schematic of one embodiment of the input drive to impact cam motion transmission component of the chisel head attachment unit of FIG. 1.

FIG. 7 illustrates the method of using a tensile springs for mechanical potential energy storage in the embodiments of FIGS. 2 and 3 instead of compressive spring.

FIG. 8A illustrates the schematic of the cross-sectional view of the basic impact generating mechanism of a second embodiment of the chisel head attachment unit.

FIG. 8B illustrates the schematic of the frontal view of the basic impact generating mechanism of a second embodiment of the chisel head attachment unit.

FIG. 9 illustrates the schematic of a “chisel head unit” embodiment with integrated electric driving electric motor.

### DETAILED DESCRIPTION

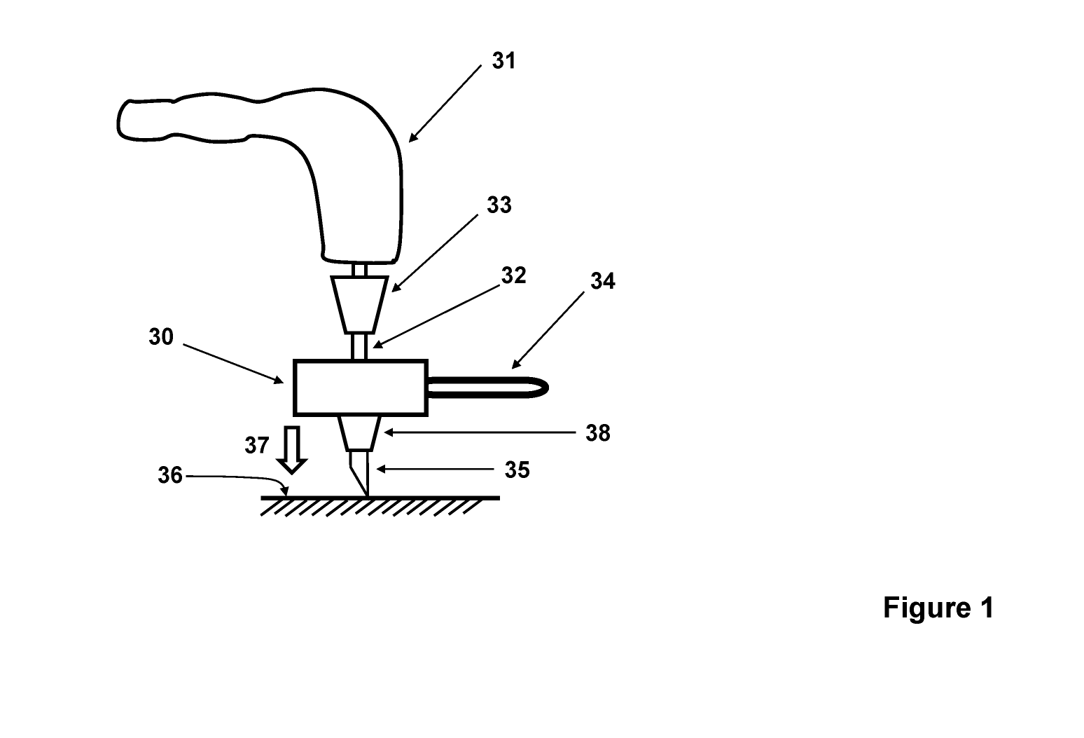

The overall view of a chisel head attachment unit 30 and an electric drill or screw driver 31 (hereinafter referred to only as the electric drill) driving it is shown in the schematic of FIG. 1. The electric drill 31 may be battery powered or powered by a line voltage and is illustrated schematically herein with the shape shown in FIG. 1. An input drive shaft 32 of the chisel head attachment unit 30 is engaged by a chuck 33 of the electric drill 31. The input drive shaft 32 of the chisel head attachment unit 30 can be provided with a hexagonal or other similar cross-sectional area geometry for better torque transmission from the chuck 33 to the input drive shaft 32. The chisel head attachment unit 30 is also provided with at least one handle 34 for the user to hold with one hand to guide and direct the chisel end 35 against the intended impacting surface 36 as the chisel end 35 travels downward in the direction of the arrow 37. The handle can be configured for both hands (while a second person operates the electric drill 31 or configured for other parts of the body, such as the knees. The chisel head attachment unit 30 can be provided with a chuck 38 to accept different types of chisel ends 35.

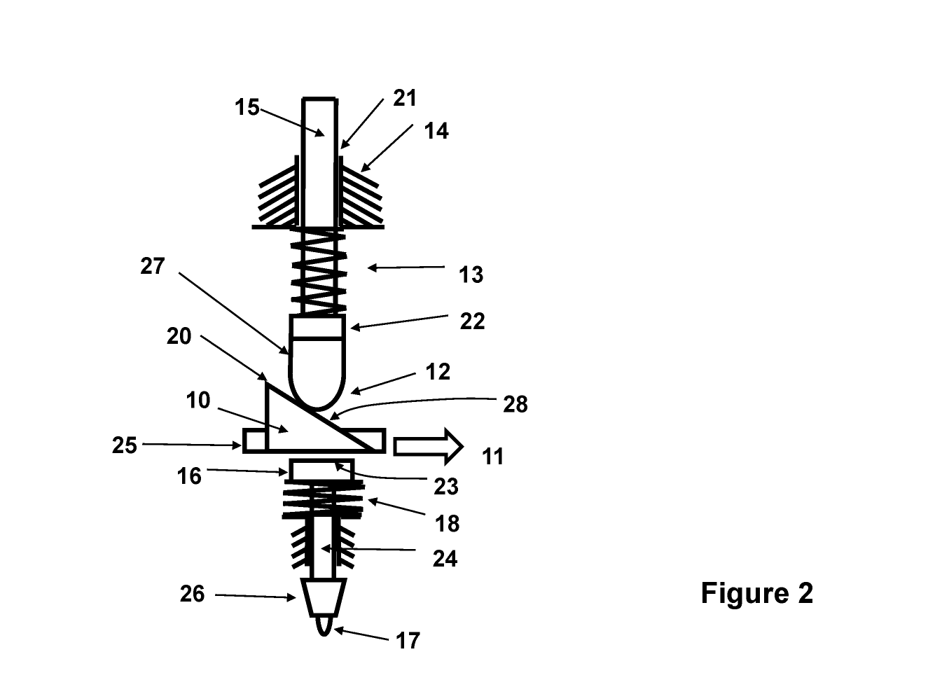

The basic operation of the mechanisms of the first embodiment of the chisel head attachment unit 30 is herein described via the overall schematic of FIG. 2. In FIG. 2 and for the sake of clarity, the main elements of the impact generating portion of the chisel head attachment unit 30 is shown alone without the aforementioned device input drive and the speed reducing gearing (if any) and its motion transmission elements for driving the impact generating mechanism. The latter mechanisms will be described later in this disclosure.

The chuck 33 of the electrical drill or screw driver 31, FIG. 1, is attached to the input drive shaft of the chisel head attachment unit 30, either directly or through a gearing or the like motion transmission unit (usually for speed reduction purposes) as was previously described. The output of the gearing or the like motion transmission unit (not shown) is then used to rotate at least one cam 10 in the direction of the arrow 11. The at least one cam 10 is attached to a disc 25 which is rotated continuously by the output of the reduction gearing or the like motion transmission unit of the chisel head attachment unit 30.

As the cam 10 is moved in the direction of the arrow 11, its inclined cam profile surface 28 will force the hammer end 12 upward, thereby compressing the potential energy storage spring 13 between the structure 14 of the housing of the chisel head attachment unit 30 and the shoulder 22 provided on the hammer 15. The hammer 15 itself can travel in the guide 21 which is provided in the structure 14 of the chisel head attachment unit 30. Then when the tip 20 of the cam 10 passes the end 12 of the hammer 15, the hammer 15 is released and the potential energy stored in the spring 13 accelerates the hammer 15 down and causes the tip 12 of the hammer 15 to impact the surface 23 of the anvil 16, thereby imparting downward momentum to the chisel 24 element, thereby allowing the user to impact the chisel head 17 against the desired object surface. After each impact, the lightly preloaded compressive spring 18 causes the chisel 24 to be pulled back and ready for the next impact by the hammer 15. In one embodiment, the chisel head 17 is attached to the chisel element 24 via a chuck 26 so that the chisel heads 17 can be quickly changed.

It is appreciated by those skilled in the art that by adjusting the amount of preload in the potential energy storage spring 13, the level of stored potential energy at the time of hammer 15 release is varied. In general, this can be the method of adjusting the level of impact between the hammer 15 and the surface 23 of the anvil 16. Alternatively, the level of impact between the hammer 15 and the surface 23 of the anvil 16 may also be adjusted by raising or lowering the anvil 16 relative to the hammer 15, noting that by reducing the distance, the level of momentum with which the hammer 15 impacts the surface 23 of the anvil 16 is reduced.

It is appreciated by those skilled in the art that as the tip 12 of the hammer 15 passes the tip 20 of the cam 10, the hammer 15 begins to be pushed down by the force of the compressively loaded potential energy storage spring 13. The tip 12 of the hammer is desired to have close to a spherical surface (such as with significantly larger diameter as shown in the schematic of FIG. 2) for proper concentration of impact force on the surface 23 of the anvil 16. As a result, the hammer 15 is not suddenly released as the lowest point on the tip 12 passes the sharp point 20 of the cam 10 and would still rub against the tip 20 of the cam until the entire stem 27 of the hammer 15 has passed the tip 20 of the cam 10.

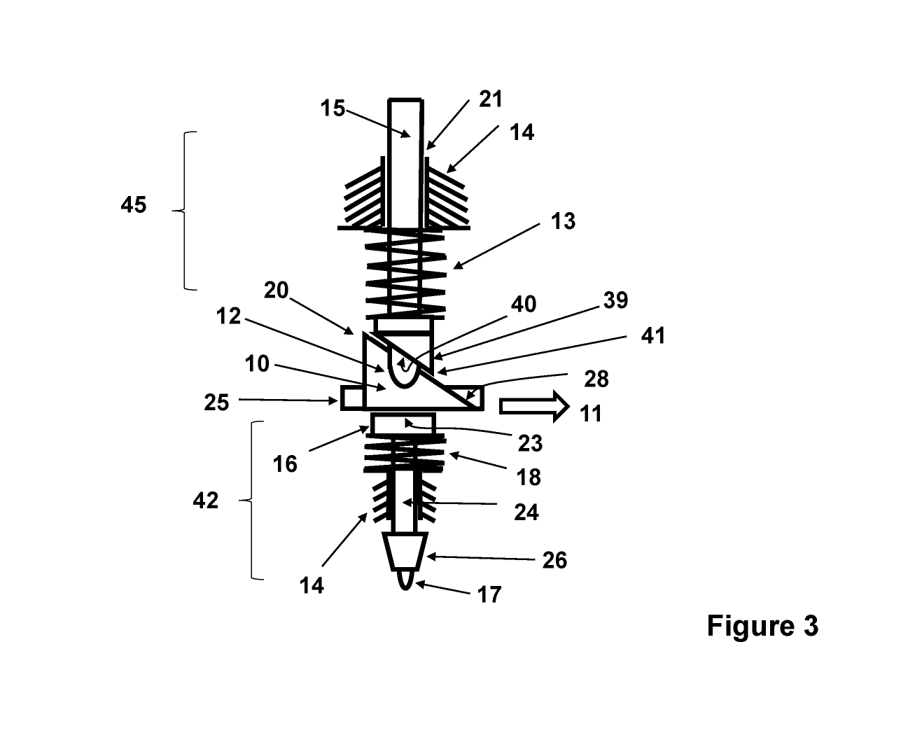

To ensure that the hammer 15 is released suddenly with minimal rubbing against the surface of the cam 10 around the tip 20, the alternative engagement and release arrangement shown schematically in FIG. 3 can be used. In this alternative embodiment shown schematically in FIG. 3, the tip 12 of the hammer 15 is no longer used to preload the potential storage spring 13 as was shown for the embodiment of FIG. 2. In the alternative embodiment of FIG. 3, the preloading of the potential storage spring 13 is achieved instead by providing the end of the hammer 15 with an (such as integral) element 39 which is provided with an inclined surface 40 which matches and rides against the inclined surface 28 of the cam 10 as the disc 25 rotates and cause the cam to travel in the direction of the arrow 11. In this embodiment, the tip 12 of the hammer 15 is positioned beyond (in front as shown in the schematic of FIG. 3) the side of the cam 10. Then as the cam 10 travels in the direction of the arrow 11, the potential energy storage spring 13 of the chisel head attachment unit 30, FIG. 1, is continuously preloaded until the tip 41 of the element 39 reaches the tip 20 of the cam 10. At which time the element 39 and thereby the hammer 15 is suddenly released. The hammer 15 is then accelerated downwards towards the surface 23 of the anvil 16. The tip 12 of the hammer 15 will then impact the surface 23 of the anvil 16 as was described previously for the embodiment of FIG. 12, thereby imparting downward momentum to the chisel element 24, thereby allowing the user to impact the chisel head 17 against the desired object surface. After each impact, the lightly preloaded compressive spring 18 will similarly cause the chisel element 24 to be pulled back and ready for the next impact by the hammer 15.

It is appreciated by those skilled in the art that for a given compressive deformation of the mechanical potential energy storage spring 13 provided by the rotation of the cam 10, FIGS. 2 and 3, the amount of mechanical potential energy stored in the spring 13 is increased by having the spring 13 be initially preloaded in compression. Such preloading is also highly desirable so that the hammer mass 15 is accelerated downwards towards the anvil 16 during at all times during its downward motion.

As was previously indicated, in different embodiments of the chisel head unit attachment 30, FIG. 1, the level of impact force between the hammer mass 15 and the anvil 16, FIGS. 2 and 3, can be adjusted by varying the distance between the tip 12 of the hammer 15 and the surface 23 of the anvil and/or by varying the amount of preload in the potential energy storage spring 13 to vary the velocity of the tip 12 of the hammer 15 at the time of impact with the surface 23 of the anvil 16.

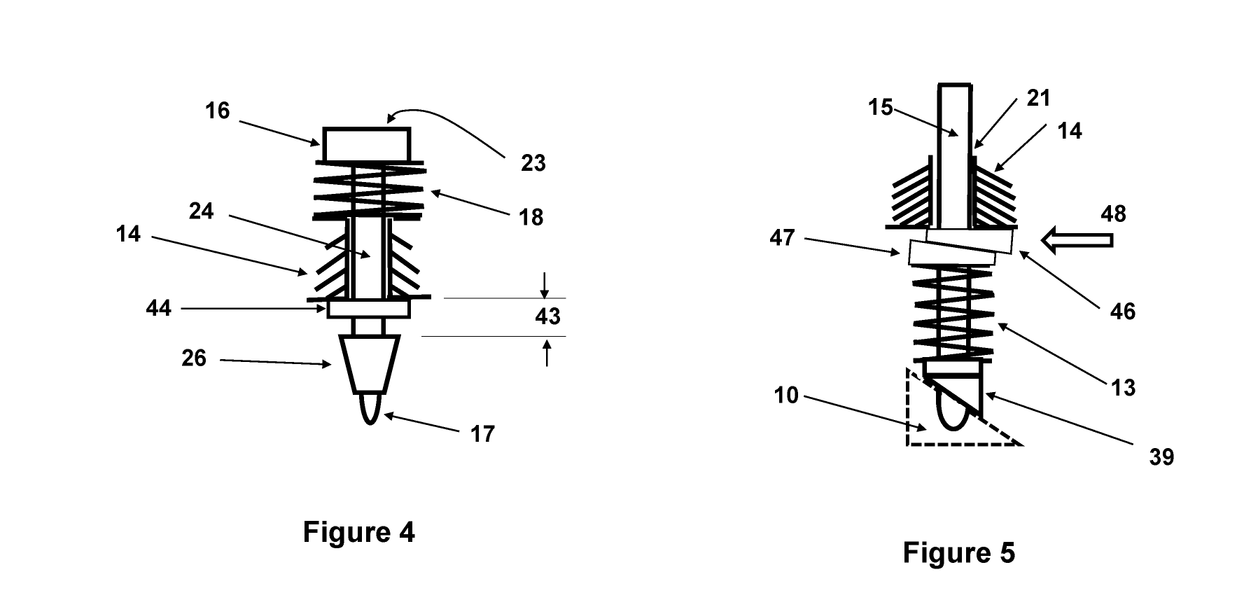

The anvil and chisel portion of the chisel head attachment unit embodiments of FIGS. 2 and 3 (indicated by the numeral 42 in FIG. 3) is redrawn in FIG. 4. To varying the distance between the tip 12 of the hammer 15 and the surface 23 of the anvil 16, the chisel element 24 is provided with an adjustment “nut” type element 44 which rides on the provided thread, which can be a fine thread, over the stem of the chisel element 24, between the chisel holder 26 and the housing structure 14 of the chisel head attachment unit 30. Then by rotating the adjustment element 44, the distance 33 and thereby the distance between the tip 12 of the hammer 15 and the surface 23 of the anvil 16 (FIGS. 2 and 3) is varied. The adjustment element 44 can be provided with position holding means (not shown) such as spring loaded engagement balls or teeth that are commonly used in adjustable devices such as torque wrenches and the like, which can have high and low marking and grading, to prevent the adjustment element 44 to turn and vary the impact level as the chisel head attachment unit 30 is being operated.

Alternatively, by varying the level of preload of the potential energy storage spring 13, the total mechanical potential energy stored in the spring 13 is varied, thereby the level of acceleration that the spring 13 imparts on the hammer mass 16 and the level of momentum with which the hammer mass 16 impacts the anvil 16 is varied. For example, by increasing the level of potential energy storage spring 13 preload (compressive preload for the case of the embodiments of FIGS. 2 and 3), the total mechanical potential energy stored in the spring 13 as the hammer mass 15 is released as previously described due to the rotation of the cam 10 in the direction of the arrow 11, since it is accelerated by a larger spring 13 force while traveling the same distance before impacting the anvil 16, therefore its velocity and thereby momentum at the time said impact is increased. The opposite effect is obviously achieved by reducing the level of preload on the potential energy storage spring 13.

It is appreciated by those skilled in the art that numerous methods known in the art may be used to provide to the user the means to manually adjust the level of preloading of the potential energy storage spring 13, FIGS. 2 and 3, an example of which is shown in the schematic of FIG. 5. In FIG. 5, the hammer and potential energy storage spring 13 portion of the chisel head attachment unit embodiments of FIGS. 2 and 3 (indicated by the numeral 45 in FIG. 3) is redrawn. Two elements 46 and 47 are then provided between the chisel head attachment unit housing structure 14 and the spring 13. The element 47 can be provided with a hole through which the stem of the hammer mass 15 is passed. The element 46 can be provided with a slot, which allows it to be moved back and forth in the direction of the arrow 48. The two elements 46 and 47 are provided with mating inclined surfaces shown in FIG. 5 so that by moving the element 46 to the left (right) the level of preloading of the potential energy storage spring 13 is increased (decreased). It is noted that since the end element 39 of the hammer mass 15 is held against the surface of the cam 10, while varying the preloading of the spring 13 does not cause the hammer mass upward or downward motion. The adjustment element 46 can be provided with position holding means either against the housing structure 14 or the element 47 (not shown), such as by the use of spring loaded engagement balls or teeth which are commonly used in adjustable devices such as torque wrenches and the like, which can have high and low marking and grading, to prevent the adjustment element 46 to displace and vary the preloading level of the spring 13 as the chisel head attachment unit 30 is being operated.

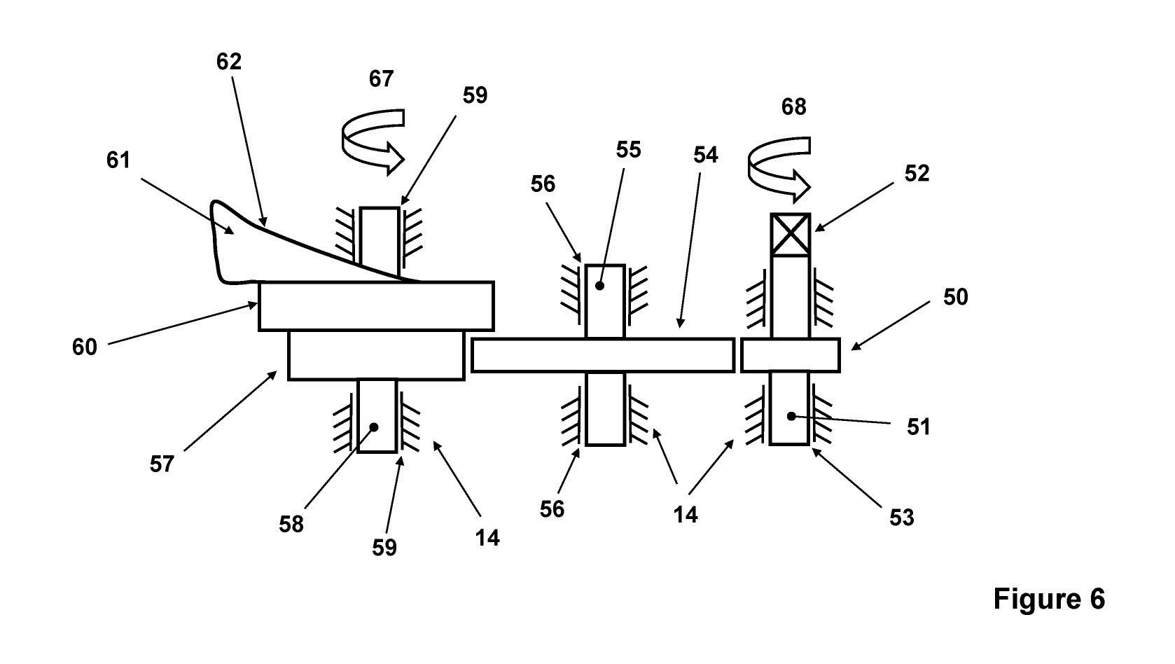

One embodiment of the input drive to impact cam motion transmission component of the chisel head attachment unit 30, FIG. 1, is shown schematically in FIG. 6. In the present embodiment of the chisel head attachment unit 30, the chuck of the aforementioned electric drill or electric screw driver is attached to the input drive 52, FIG. 6, of the chisel head attachment unit 30. The input drive 52 can be of hexagonal shape for easy and secure attachment to the electric drill or electric screw driver chuck, such as via a hex adaptor (not shown) for ease of engagement and disengagement. The input drive 52 is the end of the input shaft 51 which is free to rotate inside bearings 53 provided in the housing structure 14 of the chisel head attachment unit 30. A gear element 50 is fixedly attached to the input shaft 51, which upon rotation of the input shaft 51 by the driving electric drill or electric screw driver 31, FIG. 1. The gear 50 is engaged with the gear 54, which is also mounted on a shaft 55, which can freely rotate in bearings 56 provided in the housing structure 14 of the chisel head attachment unit 30. The gear 54 is in turn engaged with the gear 57, which is also mounted on a shaft 58, which can freely rotate in bearings 59 provided in the housing structure 14 of the chisel head attachment unit 30.

The aforementioned cam 61 (element 10 in FIGS. 2 and 3) which is used to store mechanical potential energy in the energy storage spring (element 13 in FIGS. 2 and 3) is fixedly attached to the gear 57 directly or via an intermediate (disc like) element 60. In FIG. 6 the cam surface 62 (28 in FIGS. 2 and 3) is shown to be the surface over which the mating elements of the hammer mass 16 (surface 40 in the embodiment of FIG. 3 and the tip 12 in the embodiment of FIG. 2).

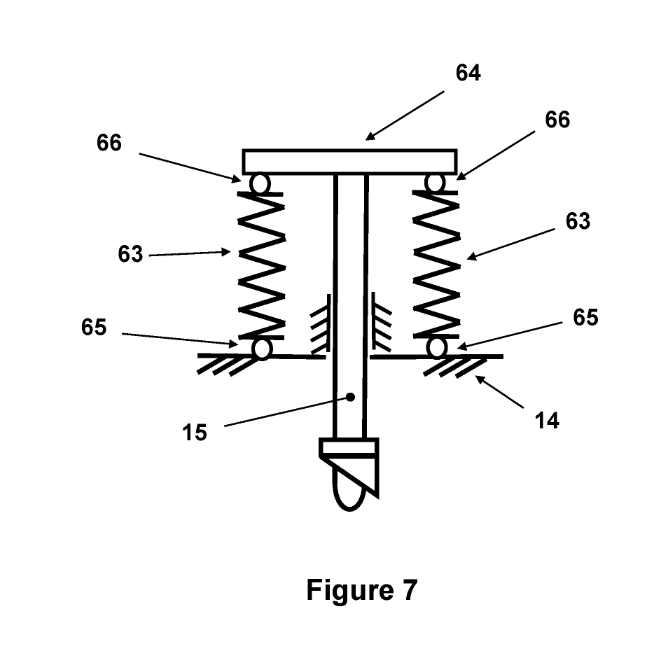

It is appreciated by those skilled in the art that as can be observed in the schematic of FIG. 7 for the cam 61 to push upward the aforementioned mating elements of the hammer mass 16 (surface 40 in the embodiment of FIG. 3 and the tip 12 in the embodiment of FIG. 2), the attaching gear 57 must be rotating in the clockwise direction as indicated by the arrow 67. This means that the input drive shaft 51 must also be rotated in the clockwise direction as shown by the arrow 68 in FIG. 7. In the schematic of FIG. 7, this is the case since the idler gear 54 reverses the direction of rotation of the input gear 50. The ratio of the number of teeth on the gear 50 to that of the number of teeth on the gear 57 indicates the reduction ration between the two gears. In general and as can be observed in the schematic of FIG. 7, the provision of the idler gear 54 allows the gears 50 and 57 to be provided with enough distance to facilitate the provision of relatively larger diameter cam 61 and disc 60, particularly for accommodating multiple cams 61. However, in an alternative embodiment, particularly when the speed reduction is not necessary or it is even desired to increase the input speed (for example when using electrical screw drivers as input drives), the idler gear 54 may be eliminated, in which case the input shaft 51 has to be driven in the counterclockwise direction, i.e., opposite to the direction of the arrow 68. In fact, in certain applications, the shaft 58 itself may be the input drive, and the (hex) head 52 may be located on the extended top portion of the shaft 58 and be driven directly by the electrical drill or electrical screw driver 31.

It is also appreciated by those skilled in the art that for the sake of simplicity, only one cam 61 is shown in the schematic of FIG. 7, even though multiple such cams may also be provided. In certain applications, one may also choose to use multiple cams with multiple profiles.

In the embodiments of FIGS. 2 and 3 and also in FIG. 5, the mechanical potential energy storage spring 13 are shown to be a (which can be preloaded) compressive spring. It is, however, appreciated by those skilled in the art that torsion and tensile (which can also preloaded in torsion and tension) springs may also be configured to be used instead. The mechanical energy storage and hammer assembly of such an embodiment is shown in the schematic of FIG. 7 (all other components shown in the schematic of FIG. 7 are identical to those of FIG. 5). As can be seen in FIG. 7, the mechanical potential energy storage spring 13 (FIGS. 2 and 3) is replaced with at least one tensile (which can be preloaded in tension) spring 63, which is attached to the housing structure 14 of the chisel head attachment unit 30, FIG. 1, on one end 65 and to the relatively rigid element 64 on the other end 66 as shown in FIG. 7. The relatively rigid element 64 is fixedly attached to the indicated end (or thereabout) of the hammer mass 15.

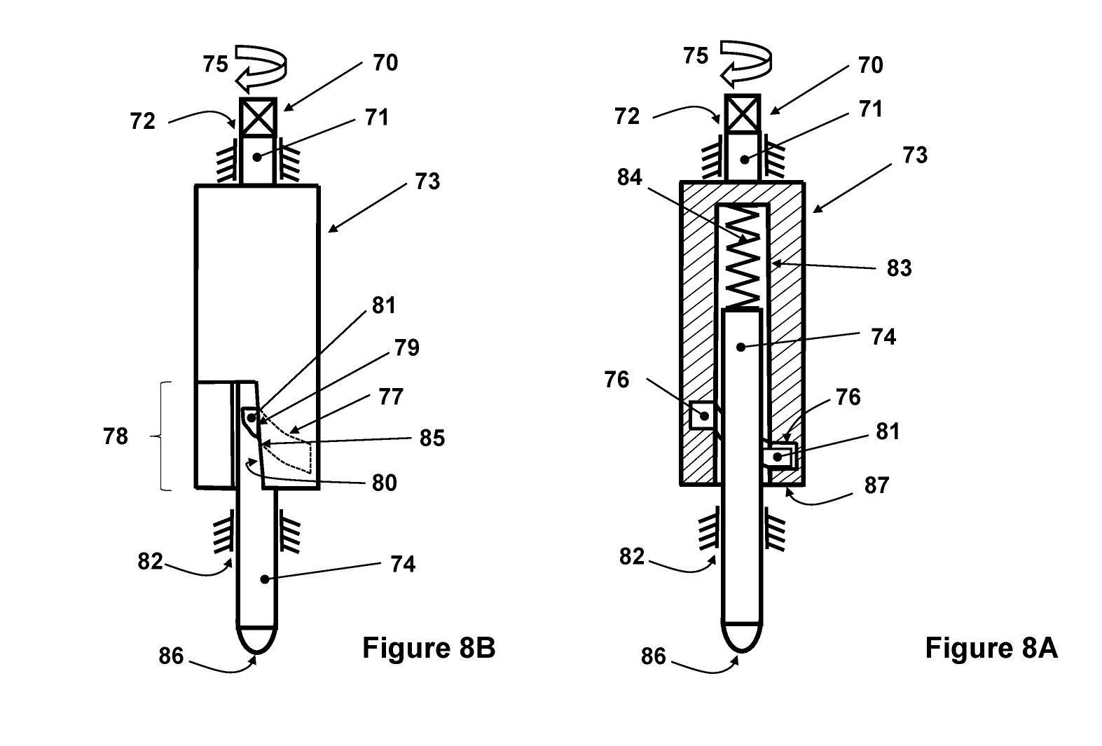

The basic operation of the mechanisms of the second embodiment of the chisel head attachment unit 30 is described via the overall schematic of FIGS. 8A and 8B. In FIGS. 8A and 8B, for the sake of clarity, the main elements of the input drive and the hammer and potential energy storage spring portion of the chisel head attachment unit 30 are shown. The anvil and chisel end assembly of the device is considered to be as was described for the previous embodiments shown in the schematics of FIGS. 2-5.

In the embodiment of FIGS. 8A and 8B, the input drive 70, which can be hexagonal in cross-section is provided for attachment to the chuck 33 of the driving electrical drill or electrical screw driver 31, FIG. 1. The input drive shaft 71, which is free rotate in the bearing 72 provided in the housing structure 14 of the chisel head attachment unit 30, FIG. 1, is fixedly attached to the housing 73 of the hammer mass 74. The rotation of the input drive 70 shown by the arrow 75 by the driving electrical drill or electrical screw driver 31, FIG. 1, would therefore rotate the housing 73. The housing 73 is provided with an internal helical groove 76 along a portion of its inner body up to the opening section 78 on a section of housing 73. It is noted that in the cross-sectional view of FIG. 8A the (square) cross-sectional view of the internal helical groove 76, which are indicated by the numeral 76. The same helical internal groove in the frontal view of the FIG. 8B is shown with dashed lines and is indicated by the numeral 77. It is also noted that in the frontal view of FIG. 8B, the open section 78 of the tubular lower section of the housing 73 is shown, where the upper end 79, FIG. 8B, of the helical groove 77 is shown to end. The surface 80 of the open section 78 at the upper end 79 of the groove 77 is shown to be nearly vertical, and can be slightly angled outward on from the vertical towards the bottom portion as can be seen in FIG. 8B.

The hammer mass 74 is positioned inside the opening 83 inside the housing 73 on one end and is free to slide up and down without rotation in the guide 82 provided in the housing structure 14 of the chisel head attachment unit 30, FIG. 1. The lower portion of the hammer mass 74 that runs inside the guide 72 can be square or is provided with splines or the like (not shown) to prevent it from rotating while traveling vertically in the guide 82 as shown in FIGS. 8A and 8B. The hammer mass 74 is also provided with the element 81, which engages the helical groove 77 as can be seen in the cross-sectional view FIG. 8A, in which the engaging element 81 is shown in the lower exposed end of the grove 76.

Then as the input drive 70 is rotated clockwise in the direction of the arrow 75, the element 81 is forced to travel (slide) up the helical groove 77, thereby forcing the hammer mass 74 to slide up inside the opening 83 of the housing 73. As a result, the mechanical potential energy storage compressive spring 84 provided in the opening 83 of the housing 73 is compressed, thereby storing mechanical potential energy. The potential energy storage spring 84 can be initially preloaded to allow larger amount of mechanical potential energy to be stored in the spring. Then as the element 81 reaches the surface 80 of the open section 78 and passes the edge 85 of the opening 79 of the helical groove 77, the element 81 is released, thereby allowing the preloaded compressive potential energy storage spring 84 to accelerate the hammer mass 74 downwards, and force the tip 86 of the hammer mass 74 to impact the surface 23 of the anvil 16, FIGS. 2 and 3, thereby imparting downward momentum to the chisel 24 element, thereby allowing the user to impact the chisel head 17 against the desired object surface as was previously described.

Then following each hammer mass 74 release, impact with the anvil and its return to its initial position, the continued rotation of the housing 73 by the electrical drill or the screw driver will bring the lower opening end 76 of the helical grove (which can be wide enough and is essentially at the level of the lower surface 87 of the housing 73, FIG. 8A) to re-engage the element 81 of the hammer mass 74, and start another cycle of potential energy storage spring 84 compression and hammer mass 74 release. The process will continue until the electrical drill or the electric screw driver 31, FIG. 1, is turned off.

It is appreciated by those skilled in the art that in an alternative embodiment, the chisel chuck 26 and the chisel end 17 (FIGS. 2 and 3) may be directly attached to the end 86 of the hammer mass 74, FIGS. 8A and 8B. Then the aforementioned momentum of the hammer mass 74 as it is accelerated downwards by the preloaded potential energy storage spring 84 following its release can be used to impact the chisel end 17 against the intended surface.

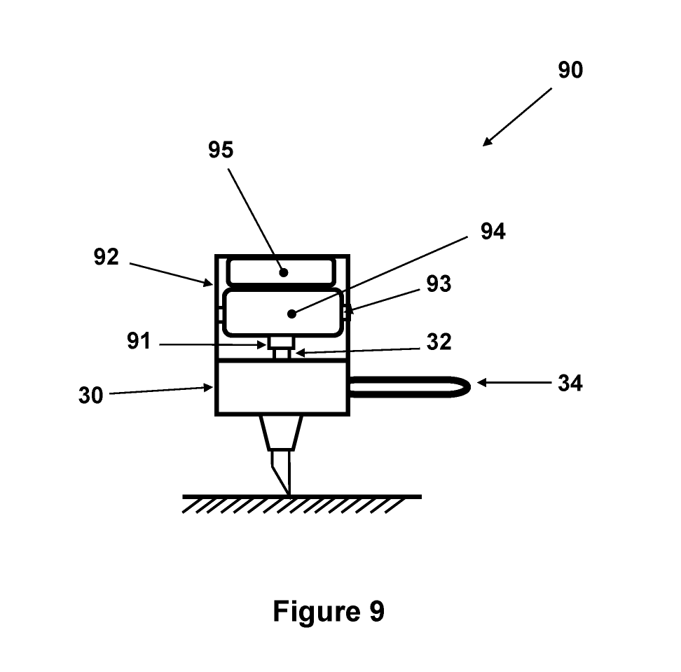

In the above embodiments, an external device such as an electrical drill or electric screw driver (31 in FIG. 1) or drill press is used to drive the input drive of the chisel head attachment units. In an alternative embodiment shown in the schematic of FIG. 9 the driving electric motor is integrated with the chisel head attachment unit to form an all-in-one electrically driven chisel 90. In such an all-in-one electrically driven chisel 90, the drive shaft 91 of the device electric motor 94 is attached to the input drive 32 of the previously described “chisel head attachment” unit 30. The electrical chisel 90 may be provided with a housing 92 to which the drive motor 94 is held fixed, for example by peripheral elements 93 that prevents its rotation relative to the housing 92. However, in one embodiment the housing 92 and the housing 14 of the chisel head portion, FIGS. 2 and 3, are integral, and in fact the entire unit 90 is designed as an integral unit to minimize the number of components and complexity.

The electric motor 94 may be powered by external power via a wire through an outlet (not shown) or via a battery pack 95.

It is also appreciated by those skilled in the art that in the all-in-one electric chisel embodiment 90 of FIG. 9, the user may or may not prefer to use the handle 34 and may also choose to hold the entire unit body in one hand. For this reason, the handle 34 may be totally eliminated or be supplied as an attachment, particularly for smaller chisel 90 units in which the chisel body is relatively small and easy to hold in one hand and that the motor torque is relatively low for the user hand to resist.

While there has been shown and described what is considered to be preferred embodiments, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for producing impacts from rotary motion, the method comprising:
inputting the rotary motion to an input shaft,
converting the rotary motion to a linear motion;
storing potential energy in one or more elastic elements resulting from the linear motion; and
releasing the stored potential energy when the stored potential energy reaches a predetermined level to accelerate an impact mass to produce the impact.

2. The method of claim 1, further comprising repeating the converting, storing and releasing for each predetermined angle of revolution of the input shaft.

3. The method of claim 1, further comprising the impact mass impacting against an output chisel head.

4. The method of claim 1, further comprising varying the predetermined level.

5. The method of claim 1, wherein the rotary motion is provided by an external device releasably connected to the input shaft.

6. The method of claim 1, wherein the rotary motion is provided by an internal motor fixedly connected to the input shaft.
